(19) United States
(12) Patent Application Publication
(10) Pub. No.: US 2026/0172315 A1
(43) Pub. Date: Jun. 18, 2026

(54) SYSTEMS, METHODS, AND APPARATUSES FOR NETWORK EVOLUTION BASED ON ARENAS AND GENETIC SCHEMA

(71) Applicant: Beyond AGI LLC, Austin, TX (US)

(72) Inventors: Marko Lehtimäki, Hyllykallio (FI); Pavel Jacko, Westbeemster (NL); Harri S. Sarsa, Berlin (DE)

(21) Appl. No.: 19/420,748

(22) Filed: Dec. 16, 2025

Related U.S. Application Data
(60) Provisional application No. 63/734,204, filed on Dec. 16, 2024.

(51) Int. Cl. H04L 41/14; H04L 41/12

(52) U.S. Cl. CPC H04L 41/145; H04L 41/12

(57) ABSTRACT

The present disclosure sets forth systems, apparatuses, and methods that enable the evolution of networks via genetic schemas. An example system determines a universe of valid mutations of a network, configures an environment to test network mutations against at least one criterion in at least one trial, generates, based on the network, based on randomized anomalies applied to at least one neuron or connection of the network, and based on the universe of valid mutations, a mutated network, deploys the mutated network within the environment for a first round having a first criterion and a first time duration, discards, based on the mutated network failing to satisfy the first criterion, the mutated network, and creates, based on the mutated network satisfying the first criterion, an updated network.

### CROSS REFERENCE TO RELATED APPLICATIONS

This patent claims priority to and the benefit of U.S. Provisional Patent Application No. 63/734,204, filed on Dec. 16, 2024, entitled “Autonomous Network Optimization via Genetic Schema and Evolutionary Arenas.” U.S. Provisional Patent Application No. 63/734,204 is hereby incorporated herein by reference in its entirety.

### FIELD OF THE DISCLOSURE

This disclosure relates generally to systems, methods, and apparatuses for network evolution based on arenas and genetic schema.

### BACKGROUND

Networks are often limited to manual configurations. To the extent current networks adapt, mutate, or evolve, such adaption, mutation, or evolution is regularly designed and implemented via a human operator. As such, network evolution is limited by human comprehension.

### BRIEF DESCRIPTION OF THE DRAWINGS

FIG. 1 is a block diagram of an example network evolution engine constructed in accordance with teachings of this disclosure.

FIG. 2 is a flowchart illustrating an example process performed by the example network evolution engine of FIG. 1 in accordance with teachings of this disclosure.

FIG. 3 is a block diagram of an example base network in accordance with teachings of this disclosure.

FIG. 4 is a flowchart illustrating an example mutation process in accordance with teachings of this disclosure.

FIG. 5 is a block diagram of an example mutated network after the example mutation process of FIG. 4 is applied to the example base network of FIG. 3 in accordance with teachings of this disclosure.

FIG. 6 is a flowchart illustrating an example process implementing trials within an evolutionary arena in accordance with teachings of this disclosure.

FIG. 7 is a flowchart illustrating an example process for recognizing zip codes with decomposed evolving subnetworks in accordance with teachings of this disclosure.

FIG. 8 is another flowchart illustrating an example process for recognizing zip codes with decomposed evolving subnetworks in accordance with teachings of this disclosure.

FIG. 9 is a flowchart illustrating example parallel processes for evolving decomposed subnetworks in accordance with teachings of this disclosure.

FIG. 10 is a block diagram illustrating resource allocation for decomposed subnetworks in accordance with teachings of this disclosure.

FIG. 11 is a flowchart illustrating a practical defense network implementation in accordance with teachings of this disclosure.

FIG. 12 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Network optimization is fundamental in all networking, and is especially important in computational networks—systems comprising interconnected nodes (processing units connected via data flow channels) performing complex processing tasks. Such computational networks may be involved in artificial intelligence (“AI”), machine learning, and other complex system modeling (e.g., neural networks, deep learning models, agentic AI systems, machine learning algorithms, and the like). Traditional optimization methods, such as gradient-based algorithms, reinforcement learning, and evolutionary approaches, have achieved notable successes. However, these methods face significant limitations when scaling to large, non-deterministic networks operating in dynamic environments.

Optimizing networks traditionally involves enhancing performance metrics like accuracy, efficiency, adaptability, and scalability, with the ultimate goal of improving a network's capabilities to handle the real-world challenges it was designed to address. Gradient-based methods may utilize differentiable loss functions to iteratively adjust network parameters, requiring labeled data and fixed topologies. For example, these methods may include backpropagation, stochastic gradient descent (SGD), and advanced gradient methods such as Adam, RMSprop, and AdaGrad. These gradient-based methods may require continuous activation and loss functions that can be differentiated with respect to the network parameters. For networks with non-differentiable components, such as discrete activation functions, binary weights, or symbolic reasoning nodes as found in some agent-based systems, gradient-based methods may not be directly applied. Additionally, such methods assume a fixed topology for the network, which may not be appropriate for dynamic or evolving systems. Gradient-based methods may also get stuck in local minima and experience vanishing gradients, which impede convergence to optimal solutions. And gradient-based methods require labeled training data, making them less effective in environments where such data is scarce or unavailable.

Reinforcement learning approaches may enable networks to learn optimal policies through environmental interactions, guided by reward signals without explicit supervision. These methods may include value-based methods (e.g., Q-learning and DQN), policy gradient methods (e.g., REINFORCE and PPO), and actor-critic methods that may combine both approaches. However, defining reward functions that accurately capture desired long-term behavior is challenging. Poor reward design may lead to unexpected or undesirable behaviors, and complex objectives often may not be easily expressed through simple reward signals. Additionally, learning through trial and error often requires extensive interaction with the environment. This may lead to high computational costs and time consumption, particularly in complex environments where meaningful experiences are rare. Balancing the exploration of new actions with exploiting known rewarding behaviors is particularly challenging in complex or non-stationary environments. Too much exploration wastes resources, while too little may miss optimal solutions. As the state and action spaces grow, the learning problem becomes exponentially more difficult. This “curse of dimensionality” makes it challenging to scale reinforcement learning to complex real-world problems. Lastly, performance degrades as the complexity of the environment or the number of variables increases.

Evolutionary algorithms may employ principles inspired by biological evolution, using population-based search, mutation, fitness functions, and other evolutionary mechanisms to evolve network configurations. Evolutionary algorithms may apply principles from biological evolution to optimize networks through iterative selection, mutation, and reproduction processes. These methods include genetic algorithms, evolutionary strategies, and neuroevolution approaches that can modify both network weights and topologies. However, maintaining and evaluating large populations of network variants may require significant computational resources. And memory and processing overhead may grow substantially with population size and network complexity.

Self-organizing systems may rely on local interactions and adaptive mechanisms without central control or explicit optimization objectives, leading to emergent global behaviors that align with desired objectives. Such approaches may enable networks to autonomously adapt their structure and behavior through local interactions and emergent properties, without centralized control. These methods draw inspiration from natural systems like neural development, swarm intelligence, and cellular automata. However, directing emergent behaviors toward desired objectives is challenging, as local interaction rules may not reliably produce intended global outcomes. The relationship between local rules and global behavior is often non-intuitive. Self-organizing systems often struggle with complex task learning and generalization to different domains, making them less effective in dynamic environments.

Complex, high-dimensional fitness landscapes may make it difficult to efficiently explore a solution space. Networks may get trapped in local optima or fail to discover promising regions of the search space. Mutations and crossover operations can produce invalid network configurations that violate architectural constraints or produce non-functional networks, wasting computational resources. Evolution-based methods typically require many generations to converge to optimal solutions, making them slower than gradient-based approaches for certain optimization tasks.

Maintaining stable network configurations while allowing for adaptation is difficult. Systems may oscillate between states or fail to converge to useful configurations. As networks grow larger, coordinating self-organization becomes increasingly complex. The overhead of maintaining local interactions and managing emergent properties can become prohibitive. The non-deterministic nature of self-organization makes it difficult to guarantee specific performance characteristics or behavioral outcomes, complicating deployment in critical systems.

Recent developments in network optimization combine multiple paradigms and leverage emerging technologies to address limitations of traditional approaches. These hybrid methods include neural architecture search, meta-learning systems, and hardware-optimized solutions that aim to improve both efficiency and effectiveness of network optimization. However, combining multiple optimization paradigms introduces significant architectural challenges. Coordinating different optimization strategies, managing cross-paradigm interactions, and ensuring consistent behavior across integrated components requires complex orchestration mechanisms. Advanced approaches often demand substantial computational resources for parallel optimization processes. Balancing resource allocation between different optimization strategies while maintaining system responsiveness becomes increasingly difficult as complexity grows.

Hybrid systems with multiple interacting components are difficult to validate thoroughly. Traditional testing approaches may miss emergent behaviors or fail to cover all possible interaction scenarios between different optimization methods. Implementing sophisticated hybrid solutions in production environments presents significant operational challenges. Managing dependencies, ensuring compatibility across different platforms, and maintaining system stability during updates require careful coordination.

Across all current optimization approaches, several fundamental challenges persist that limit their effectiveness in real-world applications. These shared limitations highlight the need for a revolutionary approach to network optimization: As networks grow in size and complexity, all current methods face severe degradation in either performance or efficiency. Gradient-based methods struggle with vanishing gradients, evolutionary approaches face exponential computational costs, and self-organizing systems become increasingly unpredictable. Traditional approaches typically optimize networks for specific, predefined objectives in controlled environments. This may lead to brittle solutions that may fail when deployed in dynamic, real-world conditions where objectives and constraints evolve over time.

Current methods struggle to maintain performance when operating conditions change. Whether using fixed architectures in gradient-based methods or population-based evolution, networks cannot efficiently adapt their fundamental structure during operation. Existing approaches often require substantial computational resources for even modest improvements. This inefficiency stems from evaluating invalid or non-viable solutions, computational overhead of maintaining and evaluating large populations simultaneously, running parallel optimization processes, processing and analyzing extensive evaluation data. Additionally, current methods are limited by their underlying assumptions about network architecture. For example, gradient-based methods require differentiable components, evolutionary approaches need explicit fitness functions, self-organizing systems lack precise control mechanisms, and recent hybrid methods introduce significant complexity in integration and orchestration.

The fundamental limitations of current approaches create an urgent need for innovation in computational network optimization. Traditional methods face persistent challenges that limit their effectiveness in modern application. Computational and memory requirements grow exponentially with network size, making large-scale optimization increasingly impractical. Current approaches rely heavily on manually-defined objectives and fitness functions limits autonomous operation. Often these approaches have poor performance in dynamic, unpredictable environments and weak generalization to new scenarios, limited ability to discover novel solutions due to constrained exploration spaces, poor resource utilization and slow response to changing conditions. These challenges suggest that traditional optimization approaches may be reaching their practical limits. A fundamentally different approach to network optimization is needed-one that may scale efficiently to handle growing network complexity without exponential resource costs, adapt continuously by responding dynamically to changing conditions without manual intervention, operate autonomously by functioning without explicit fitness functions or human-defined objectives, ensure network configurations remain viable throughout evolution, and foster the development of sophisticated, novel behaviors. Such an approach would represent a paradigm shift in network optimization, moving beyond the limitations of current methods toward truly adaptive, self-evolving systems. In some examples, making conscious architectural decisions about extremely complex networks may require computational resources greater than those needed to run the networks themselves, as understanding and reasoning about complex architectures may demand more processing power than executing them. In some examples, this creates a fundamental limitation where the cost of manual optimization grows faster than the systems being optimized.

To that end, the systems, methods, and apparatuses described herein provide a genetic mutation clone mechanism for generating node graph mutations within networks. In some examples, the systems, methods, and apparatuses described herein introduce variations within the network's architecture to mimic biological mutation processes, explore novel configurations, and develop the same. These mutations may be cloned and tested to identify enhancements in network performance, which may lead to the potential discovery of superior generative capabilities. To accomplish this, the systems, methods, and apparatuses described herein include a genetic schema that may establish valid mutations while maintaining network integrity, which may be applied within evolutionary arenas with survival-based challenges to apply natural selection to evolving computational networks. In some examples, the systems, methods, and apparatuses described herein may eliminate a need for explicit fitness functions by using survival-based criteria, guarantee valid mutations through statically analyzable genetic schema constraints, enable continuous adaptation during operation, as each mutated variant may be immediately operational, and foster emergence of complex behaviors through accumulated mutations, resulting in an autonomous advancement over traditional optimization techniques.

The example genetic schema may be a structural system of rules that identifies valid network mutations and preserves the integrity of network operations to ensure that a given mutation produces a viable, functional network. For example, the genetic schema may comprise type compatibility constraints, performance boundaries (e.g., latency, memory, etc.), behavioral constraints, interface specifics, maximum mutation variants per generation, minimum variant diversity thresholds, target survival rates, stability rules (e.g., configuration similarity thresholds), and the like.

The example evolutionary arenas may be testing environments in which the survival of networks may be challenged based on specific performance criteria. In some examples, the survival criteria may be binary, such that a mutation either survives or fails, in contrast to fitness scores. In some examples, environmental conditions may determine viability. In some examples, the evolutionary arenas may be a complete reality to a network, such that the network may not be able to see beyond arena boundaries.

In some examples, the specific design, configuration, and evolution of evolutionary arenas themselves may be pre-determined. In some examples, the systems, methods, and apparatuses described herein may receive arena configurations as input parameters. In some examples, arena configurations may be preconfigured. In some examples, arena configurations may be determined by external systems. As disclosed herein, the evolutionary arenas provide an environment with defined survival criteria against which network variants may be tested, and that the randomized mutation and selection mechanisms described herein operate within or in response to those environments.

In some examples, a network's configuration may be a basis for mutations and evolution within the evolutionary arenas and according to the genetic schema. The network configuration may be a complete specification of a computational network, including overall system architecture, connection topology between neurons, signal flow pathways, and operational settings. In some examples, the network itself is the emergent outcome of placing multiple neurons together and connecting them. In some examples, a neuron's DNA may be the specific behavioral pattern of an individual computational node (where “neuron” and “node” are used interchangeably herein to refer to processing units within the network) and may comprise core processing characteristics, parameter configurations, and interaction patterns with other nodes. In some examples, each neuron may have individualized neuron DNA outlining that neuron's behavior. In some examples, when mutating a network, the systems, methods, and apparatuses described herein may mutate individual neurons' DNA within that network, such that mutations occur at the neuron level rather than at a network level.

In some examples, different parameters may have different mutation impacts and probabilities. In some examples, temperature parameters may have the highest impact for LLM interaction nodes, such that small temperature changes (e.g., changes of 0.1 or less) may produce massive behavioral effects due to the non-deterministic and generative nature of LLM outputs. In some examples, such high-volatility parameters may be prioritized for mutation, having mutation rates of, for example, 0.2 or higher, to ensure adequate exploration of critical parameter space that disproportionately affects network behavior. In some examples, the mutation rates for high-volatility parameters may be anywhere between 0 and 1. In some examples, evolutionary significance may determine which genes mutate most frequently. In some examples, high-volatility genes may receive higher mutation rates to explore critical parameter space.

In some examples, connection topology parameters may have similarly high mutation importance as temperature parameters. In some examples, connection topology parameters may define how signal pathways split across nodes (e.g., whether a connection branches to two nodes or three nodes). In some examples, topology mutations may produce cascading structural effects that fundamentally alter information flow through the network, making these parameters critical for evolutionary exploration alongside generative parameters. In some examples, topology change parameters may have mutation rates of, for example, 0.2 or higher to ensure adequate exploration of architectural variations. In some examples, the mutation rates for topology change parameters may be anywhere between 0 and 1.

In some examples, a variant may be a mutated or evolved network created by applying valid modifications to neurons within a base network's configuration and/or adapted based on trials within an evolutionary arena. In some examples, the systems, methods, and apparatuses disclosed herein may measure a (absolute) difference between a variant and an original network. In some such examples, this difference may be referred to as configuration drift, and may be determined by comparing key characteristics between the variant and original network configurations. In some examples, configuration drift may be acceptable when it is within a range (e.g., between 0.001 and 0.01). In some examples, the systems, methods, and apparatuses disclosed herein may measure a difference between concurrent network variants. In some examples, this may be referred to as variant diversity.

In some examples, the systems, methods, and apparatuses disclosed herein may monitor network performance of the original network and its variants. In some examples, the network performance may be monitored against survival criteria (e.g., specific performance thresholds that a network is to meet to survive an evolutionary arena). In some examples, the systems, methods, and apparatuses disclosed herein may monitor a survival rate (e.g., a proportion of trials where a variant successfully meets all survival criteria). In some examples, the systems, methods, and apparatuses disclosed herein may monitor gene-specific evolution patterns. In some examples, the systems, methods, and apparatuses disclosed herein may monitor a mutation rate (e.g., a frequency and magnitude of changes applied to a network configuration during evolution). In some examples, the systems, methods, and apparatuses disclosed herein may monitor mutation effectiveness (e.g., a rate at which mutations lead to improved network performance). In some examples, the systems, methods, and apparatuses disclosed herein may monitor resource efficiency (e.g., use of computational and memory resources by a network variant). In some examples, the systems, methods, and apparatuses disclosed herein may monitor evolutionary pressure (e.g., a combined effect of arena challenges and survival criteria that drive network evolution). In some examples, networks that are unable to withstand the evolutionary pressure may not survive to pass on their characteristics to subsequent networks (e.g., other generations). In some examples, the systems, methods, and apparatuses disclosed herein may conduct rolling window comparisons. In some examples, the systems, methods, and apparatuses disclosed herein may perform historical trend analysis.

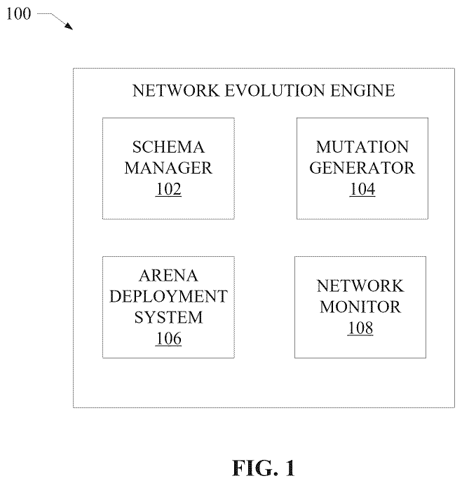

FIG. 1 illustrates an example network evolution engine 100 in accordance with the systems, methods, and apparatuses for network evolution based on arenas and genetic schema disclosed herein. The example network evolution engine 100 may act upon any types of networks, including computational networks, and comprising any number of neurons or nodes. In some examples, the example network evolution engine 100 may mutate one or more neurons of a network according to a genetic schema, and deploy such mutations within evolutionary arenas to face challenges and trials that test the mutations' survivability. In some examples, the mutations may be deployed within a sandbox, so as to not affect the network during arena operations. In some examples, mutations that survive the arena may be applied to the network. In some examples, applying the mutations to the network may involve changing an individual neuron's DNA.

The example network evolution engine 100 may comprise a schema manager 102, mutation generator 104, an arena deployment system 106, and a network monitor 108. In some examples, the schema manager 102 may establish one or more rules outlining valid mutations that can be applied to a network's configuration (e.g., a genetic schema). For example, the one or more rules may identify certain components (e.g., neurons, connections, etc.) that can (or cannot) mutate. In some examples, the one or more rules may identify certain aspects of certain components that can (or cannot) mutate. In some examples, the one or more rules may identify a level of mutation (e.g., how much a component or aspect thereof can mutate). In some examples, the one or more rules may establish a probability of mutation (e.g., a likelihood that a mutation will occur). In some examples, a parameter of a node may have a particular value range between a minimum number and a maximum number, n number of steps in a discrete increment example, specific values (e.g., value_1, value_2, . . . value_n) in a discrete value example, and a mutation probability (between 0 and 1). Example 1 illustrates an example schema in accordance with the foregoing.
gene_parameters:
   node_type:
      parameter_name:
         range: [min, max]
         step: n #Valid value bounds #Discrete increments
         mutation rate: 0.0-1.0
      or #Probability of mutation
         enum: [value1, value2, . . . ] #Discrete options
         mutation_rate: 0.0-1.0

### Example 1

Example 2 illustrates another example schema with exemplary numbers.
#Genetic schema identifying valid mutations
node parameters: #components that can mutate
   conv2d:
      filters:
         range: [32, 256] #Valid gene values
         step: 8
         mutation_range: [8, 64] #How much this gene can mutate
per generation
   mutation rate: 0.2 #Probability of this gene mutating
   kernel_size:
   enum: [[3,3], [5,5], [7,7]] #Discrete gene variants
   mutation_rate: 0.1
   activation:
   enum: [relu, leaky_relu]
   mutation rate: 0.1 dense:
units:
   range: [128, 1024]
   step: 32
      mutation range: [32, 128]
      mutation_rate: 0.2
   activation:
      enum: [relu, tanh]
      mutation rate: 0.2
   dropout_rate:
      range: [0.1, 0.5]
      mutation_range: [0.1, 0.5]
      mutation rate: 0.15

### Example 2

In some examples, the mutation generator 104 may generate network mutations based on the genetic schema and based on an underlying network. In some examples, the mutation generator 104 may generate network mutations between rounds of trials set forth in an evolutionary arena. In some examples, the underlying network is an original network (e.g., a network before exposure to an evolutionary arena round). In some examples, the underlying network is an adapted network (e.g., a network updated comprising a mutation and/or adapted based on exposure to at least one evolutionary arena round). In some such examples, therefore, the mutation generator 104 may be able to select between multiple networks (e.g., an original network and an adapted network) to use for generating network mutations in subsequent rounds of trials in the evolutionary arena.

In some examples, the mutation generator 104 may generate mutations randomly. Such random mutation generation may enable mutations beyond human comprehension, as the human mind is not capable of comprehending the possibilities created via random mutation of each neuron and/or connection within a network. In some examples, the mutation generator 104 may generate mutations according to a mutation rate. In some examples, the mutation rate is variable based on deterministic logic and/or feedback from network evolution monitoring as disclosed herein. In some examples, the mutation generator 104 may generate specific mutation variants according to objectives. In some examples, the mutation generator 104 may generate mutations as a first process and the mutations may be applied to the underlying network as a second process. In some examples, the mutation generator 104 may generate a mutated network in a single process by cloning network neurons and applying anomalies or random variations thereto. In some examples, the mutation generator 104 may cooperate with the network monitor 108 to track mutation patterns.

The mutation generator 104 may provide its generated mutations to the arena deployment system 106. In some examples, the mutation generator 104 may continuously generate mutations. In some examples, the mutation generator 104 may generate mutations based on an indication from the arena deployment system 106 that additional mutations are needed. In some examples, the mutation generator 104 may generate mutations between rounds of the evolutionary arena. In some examples, the arena deployment system 106 and/or the network monitor 108 may provide indications for adjusting mutation parameters such as, for example, current variant success rates, mutation effectiveness patterns, and/or parameter-specific volatility. In some examples, the arena deployment system 106 and/or the network monitor 108 may indicate that mutation rate should increase where configuration similarity exceeds a threshold (e.g., greater than 90%), viable variant count drops below a minimum threshold (e.g., 5 viable variants), configuration drift stagnates (e.g., drift is below 0.001), or behavior variance is below a threshold. In some examples, the arena deployment system 106 and/or the network monitor 108 may indicate that mutation rate should decrease where survival rates drop significantly, multiple viable variants emerge rapidly, networks show instability patterns, or performance degrades unexpectedly.

In some examples, evolution may occur in phases. For example, in an early mutation phase (e.g., generations 1-100), it may be acceptable to have high configuration drift (0.1-0.5 per generation), many viable variants (20+), low variant similarity, and high mutation magnitude. In a mid-stage mutation phase (e.g., generations 101-1000), it may be acceptable to have moderate drift (0.01-0.05), a stable number of variants (10-15), increasing variant similarity, and targeted mutation adjustments. In a risk detection phase (e.g., generation 1001), the systems, methods, and apparatuses described herein may be on alert and looking for evolution stagnation where configuration similarity is approaching threshold (e.g., 0.89->0.90), viable variants are declining and approaching threshold (e.g., 6->5), drift rate is slowing (e.g., 0.002->0.001). In some examples, the mutation rate may be increased. In an intervention phase (e.g., generations 1002-1100), new viable variants may emerge, variant similarity may reduce, drift rate may increase, and performance maintains stability.

Examples 3-4 illustrates example network configuration mutations.
mutation_process:
   timing: between_rounds #Critical: randomness introduced during cloning, not
within rounds
   mechanism: copy_with_errors
   error_introduction:
      neuron_parameters:
         temperature: 0.2 #High mutation rate for high-impact parameters
         layer_size: 0.1
         activation: 0.05
      connections:
         weight_variance: 0.15
         topology_changes: 0.2 #High mutation rate for structural changes
      validation: schema_enforcement

### Example 3

#Example mutations
mutations:
   type: modify_gene
      target: Conv2D_1
      parameters:
         filters: 96 #Mutated from 64
         kernel_size: [5,5] #New enum value selected from [3,3], [5,5], [7,7]
   type: add_gene
      location: after (MaxPool2D_1)
      gene:
         type: Conv2D
         filters: 64
         kernel size: [3,3]
   type: adjust gene
      target: Dense_1
      parameter: dropout_rate
      new_value: 0.3

### Example 4

In some examples, the arena deployment system 106 may deploy mutated network variants within evolutionary arena instances. In some examples, the arena deployment system 106 may subject a mutated network variant to one or more challenges based on arena configurations. In some examples, the arena deployment system 106 may establish one or more survival criteria for a mutated network variant to meet for the mutated network variant to be deemed a successful variant. In some examples, the one or more survival criteria may be different from the one or more challenges. In some examples, an evolutionary arena instance may comprise multiple rounds, with each round having a timed lifespan (e.g., 24 hours) during which network variants operate and are evaluated. During a round, a network variant may adapt and evolve through reasoning and learning mechanisms, but such adaptations may be deterministic responses to environmental challenges rather than random mutations. In some examples, the arena deployment system 106 may cooperate with the network monitor 108 to determine if a mutated network variant meets or fails to meet the survival criteria during a round. In some examples, the arena deployment system 106 may set up numerous trials within a single round. If a mutated network variant fails to meet a survival criteria in any trial, the arena deployment system 106 may terminate that round. If a mutated network variant meets a survival criteria threshold for a given trial, the arena deployment system 106 may count that trial as successful. In some examples, the arena deployment system 106 may compare a successful trial count associated with a mutated network variant against a threshold or other successful trial counts associated with other mutated network variants to determine which variant should become the next base network (e.g., the variant with the highest successful trial count, one or more variants with successful trial counts exceeding a threshold, etc.). In some such examples, the comparison may occur between rounds of the evolutionary arena instance. In some examples, the comparison may occur after all rounds of the evolutionary arena instance.

Examples 5-6 illustrates example survival criteria and challenges. While certain numbers, sources, challenge types, and threshold values are shown in Example 6 for exemplary purposes, the numbers may be any number n, the sources may be any data source, the challenge types may be any specific task domain, and the threshold values may be any value and may be configured as minimum or maximum thresholds as shown in Example 5.
challenge_type: [specific task domain]
challenge_parameters:
   dataset: [data source]
   batch_size: n
   evaluation_steps: n
   round_duration: [timespan]
survival_criteria:
   metric 1: >=threshold
   metric 2: <=threshold
   metric 3: <=threshold

### Example 5

#Arena survival criteria and challenges
challenge_type: image_classification
challenge_parameters:
   dataset: cifar10
   batch size: 32
   evaluation_steps: 1000
   round duration: 24 hr
survival criteria:
   accuracy: >=0.92
   inference_time: <=15 ms
   memory_usage: <=750 MB

### Example 6

The example network monitor 108 may maintain effective evolutionary pressure by implementing sophisticated monitoring and control mechanisms. In some examples, metrics such as accuracy or survival rate may not capture loss of evolutionary diversity, such that a network may become stagnant despite having high performance (e.g., because new solutions may not be explored). In some such examples, only minor variations may survive, structural mutations may become ineffective, variants may cluster around narrow behaviors, and evolutionary potential may diminish while performance metrics remain stable. Thus, in some examples, the network monitor 108 may track and manage evolutionary progress to prevent stagnation and ensure continued adaptation. In some examples, the network monitor 108 may monitor genetic drift from origin, variant diversity metrics, success of different mutation patterns, variant success rates, mutation effectiveness patterns, and/or parameter-specific volatility. Example 7 illustrates an example measurement of network configuration drift. While certain numbers are shown in Example 7 for exemplary purposes, the numbers may be any number n or value.
configuration_drift:
   absolute drift:
      from_origin: 0.015 #Distance from original configuration
      rolling_window: 100 #Compare against recent history
   historical trend:
      generation: 13
         drift: 0.012
      generation: 14
         drift: 0.014

### Example 7

Example 8 illustrates an example analysis of variant diversity. While certain numbers are shown in Example 8 for exemplary purposes, the numbers may be any number n or value (with the similarity and variance parameters being between 0 and 1).
diversity_metrics:
   configuration_similarity: 0.85 #% similarity to base network
   viable variants: 12 #Successful mutations count
   behavioral_variance: 0.34 #Functional diversity measure

### Example 8

Example 9 illustrates an example analysis of mutation frequency, success, impact, and volatility. While certain numbers are shown in Example 9 for exemplary purposes, the numbers may be any number n or value (with the frequency, impact, and volatility scores being between 0 and 1).
gene_evolution:
   parameter_name:
      mutation_frequency: 0.25
      successful mutations: 45
      average_impact: 0.12
      volatility_score: 0.78 #Higher for temperature parameters

### Example 9

Example 10 illustrates an exemplary analysis of gene mutations and rates, ranges, and volatility thereof. While certain numbers are shown in Example 10 for exemplary purposes, the numbers may be any number n or value (with the rates and volatility weights being between 0 and 1).
mutation_parameters:
   genes_per_mutation: [1, 5]
   gene_mutation_rates:
      temperature_parameter:
         valid_range: [0.0, 2.0]
         mutation rate: 0.3 #High mutation rate for high-impact
parameters
   volatility_weight: 0.9 #High impact=higher weight
layer_size:
   valid_range: [32, 256]
   mutation rate: 0.1 #Lower rate for structural parameters
   volatility_weight: 0.4

### Example 10

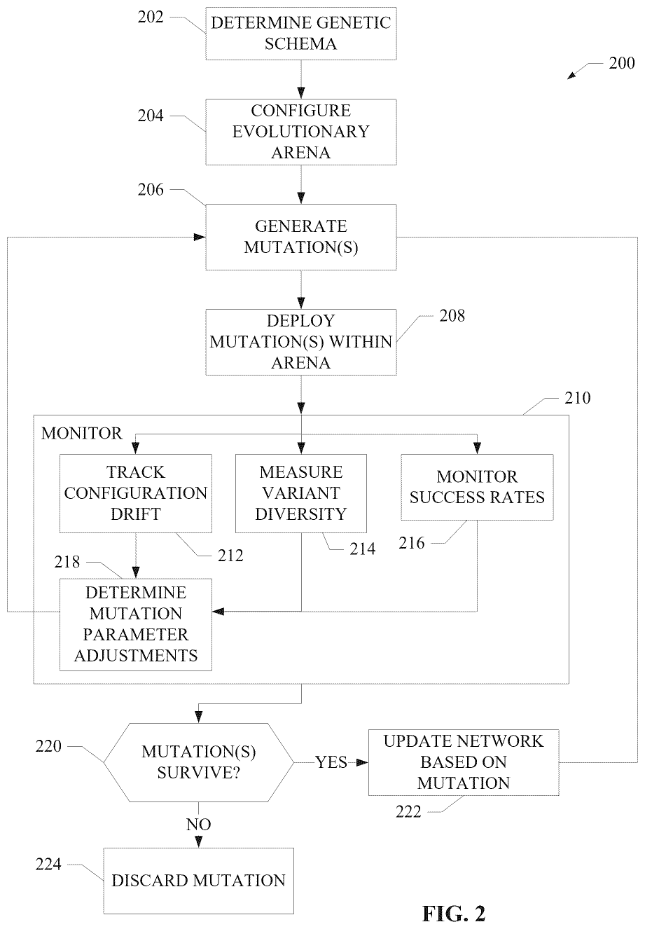

In operation, the example network evolution engine 100 may generate network mutations based on neurons of a network, test the generated network mutations across number rounds of challenges and measured against survival criteria, determine successful (and unsuccessful) mutations, apply successful mutations to the network to generate an evolved network, and continuously evolve the network by repeating this process. For example, the network evolution engine 100 may implement an example network evolution process 200 as shown in FIG. 2. In some examples, the network evolution process 200 may be applied to valid computational networks.

The network evolution process 200 may begin at step 202, where the schema manager 102 may determine a genetic schema for a network as described above. At step 204, the arena deployment system 106 may configure an evolutionary arena based on a configuration of arena parameters. At step 206, the mutation generator 104 may generate one or more mutations based on the network. At step 208, the arena deployment system 106 may deploy the one or more mutations within the one or more instances of the evolutionary arenas for a timed round (e.g., 20 minutes, 1 hour, 12 hours, a day, 3 days, a week, etc.) with particular survival criteria. In some examples, the arena deployment system 106 may deploy the one or more mutations in a single evolutionary arena instance with common challenges and survival criteria so that the mutations may compete with each other in a survival of the fittest scenario. In some examples, the arena deployment system 106 may deploy the one or more mutations within individual evolutionary arena instances with varying challenges and survival criteria for diverse mutations. In some examples, the arena deployment system 106 may deploy the one or more mutations in a hybrid approach, with some evolutionary arena instances having a single mutation therein while other evolutionary arena instances have multiple mutations therein. In some examples, the arena deployment system 106 may conduct multiple trials or rounds with one or more mutations within one or more evolutionary arena instances.

At step 210, the network monitor 108 may monitor the one or more mutations within the one or more evolutionary arena instances for the timed duration. The network monitor 108 may track configuration drift from the base network at step 212. The network monitor 108 may measure variant diversity, including the magnitude of mutations and gene-specific mutation effectiveness, at step 214. The network monitor 108 may monitor success or survival rates at step 216. At step 218, the network monitor 108 may determine mutation parameter adjustments based on the tracked configuration drift, the measured variant diversity, and/or the monitored success rates from steps 212, 214, and 216 respectively. In some examples, the network monitor 108 may send the determined mutation parameter adjustments to the mutation generator 104 for the generation of additional mutation(s) during the next round.

In some examples, the network monitor 108 and/or the arena deployment system 106 may determine, based on the monitored metrics (such as, for example, survival criteria), whether one or more mutations survive that round of the arena instance(s) (step 220). In some examples, the network mutation may have to meet all survival criteria to survive. In some such examples, if a network mutation fails any criterion, that round may be deemed a failure. If the network monitor 108 and/or the arena deployment system 106 determines that one or more mutations survive the round (step 220: YES), the network monitor 108 and/or the arena deployment system 106 may update the network based on the one or more mutations (step 222). In some examples, the ability to clone adapted networks enables a form of inheritance of acquired characteristics, where successful learned behaviors discovered during a network's operational lifespan can be passed to the next generation, thereby accelerating evolutionary progress beyond what random mutation alone could achieve. In some examples, this differs fundamentally from biological evolution, where only genetic material is inherited and learned behaviors cannot be directly transmitted to offspring.

In some examples, the network monitor 108 and/or the arena deployment system 106 may update the network based on all surviving mutations. In some examples, the network monitor 108 and/or the arena deployment system 106 may count a number of successful trials that a mutation survives. In some examples, the network monitor 108 and/or the arena deployment system 106 may update the network based on any surviving mutations that have a successful trial count over a threshold. In some examples, the network monitor 108 and/or the arena deployment system 106 may update the network based on the mutation having the highest successful trial count. Thereafter, the mutation generator 104 may generate additional mutations at step 206 based on the updated network and/or the mutation parameter adjustments determined at step 218 for the next round. If the network monitor 108 and/or the arena deployment system 106 determines that a mutation does not survive the arena (step 220: NO), the mutation may be discarded or destroyed (step 224). The network evolution process 200 may be repeated continuously across generations. Examples 11-12 illustrates an example rounds and generational structures.

### Evolutionary Arena Structure

Round 1 (e.g., 24 hours)
Network variant operates
Multiple trials executed (e.g., 100 trials)
Each trial: success or failure against survival criteria
Survival rate calculated: successes/total trials
Cloning Phase (between Round 1 and Round 2)
Select survivors based on survival rates
Choose base version (original or adapted)
Clone network neuron-by-neuron
Inject random mutations during cloning per genetic schema
Validate mutations
Round 2 (24 hours)
New mutated variants operate
Multiple trials executed
Survival assessed
Cloning Phase (between Round 2 and Round 3)
Select survivors
Clone with mutations
Continues across generations . . .

### Example 11

Generation 1: Deploy→Round 1→Survival Check→Clone survivors with mutations
Generation 2: Deploy→Round 2→Survival Check→Clone survivors with mutations
Generation 3: Deploy→Round 3→Survival Check→Clone survivors with mutations
. . . continues indefinitely

### Example 12

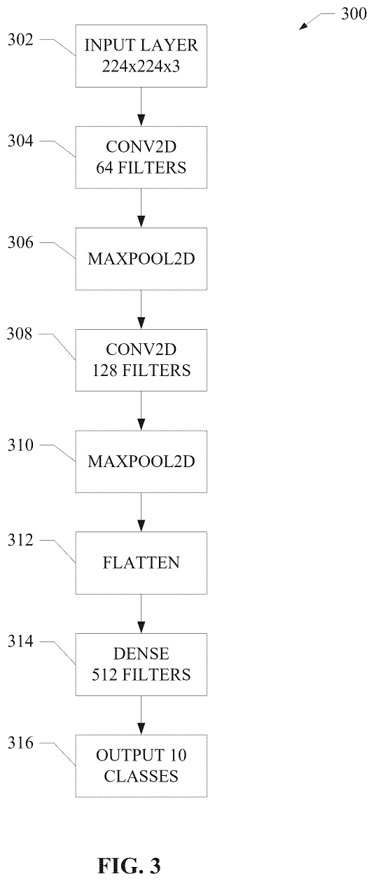

FIG. 3 illustrates an example base network 300 upon which the network evolution process 200 may be applied. The example base network 300 may comprise an input layer 302 (224×224×3), a first convolutional layer 304 (64 filters), a first max pooling layer 306, a second convolutional layer 308 (128 filters), a second max pooling layer 310, a flattening layer 312, a dense layer 314 (512 units), and an output layer 316 (10 classes). The base network may have various configurations, with the base network 300 of FIG. 3 being provided as an illustrated example.

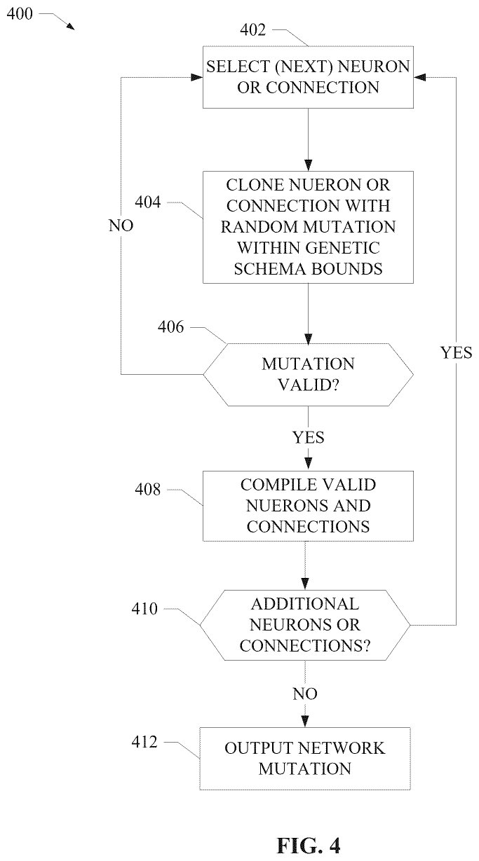

FIG. 4 illustrates an example mutation process 400. In some examples, the mutation process 400 may implement step 206 described above with reference to FIG. 2. Similar to the discussion above, the mutation process 400 may be applied to an original network (a network before a round within the evolutionary arena) or an adapted network (e.g., a network after a round within the evolutionary arena with any mutations and any adaptions that were necessary to survive). In some examples, the mutation generator 104 may select between the original and adapted network to determine whether to pass down mutated or learned characteristics during network cloning. For example, the mutation generator 104 may determine to pass down acquired characteristics rather than just genetic traits. In some examples, the mutation generator 104 may be preconfigured to always clone the original network. In some examples, the mutation generator 104 may be preconfigured to always clone the adapted network. In some examples, the mutation generator 104 may statistically determine to clone either the original or adapted network. For example, the mutation generator 104 may evaluate metrics monitored by the network monitor 108 to determine which network will produce better evolutionary outcomes in the near term (e.g., the next round). In some examples, the mutation generator 104 may utilize generational data to determine whether the original or adapted network may produce better evolutionary outcomes over many generations.

In some examples, different arena configurations may factor into which network (original or adapted) the mutation generator 104 may use to generate mutations for the next round. In some examples, the mutation generator 104 may determine optimal strategy through meta-analysis of evolutionary progress by tracking statistical outcomes across multiple generations (e.g., hundreds or thousands of rounds) to identify whether cloning from original networks or adapted networks produces superior evolutionary outcomes in terms of stability, diversity maintenance, performance trends, and long-term adaptation capabilities. In some examples, this meta-evolutionary optimization may be performed automatically without human intervention.

In some examples, the mutation process 400 may begin at step 402, where the mutation generator 104 may select a neuron or a connection from the (original or adapted) network. At the beginning of the mutation process 400, the mutation generator 104 may select a first neuron. At step 404, the mutation generator 104 may clone or otherwise copy the selected neuron or connection, and introduce a random mutation, anomaly, or variation to the copied selected neuron or connection. In some examples, the introduced random mutation may be within the bounds of the genetic schema (e.g., according to a mutation rate, within a set number of neuron mutations, etc.). In some examples, high-volatility genes (e.g., temperature parameters) may mutate more frequently. Example 13 illustrates an example cloning configuration.
cloning_configuration:
   source_version: [original|adapted]
   selection_criteria: [statistical|preconfigured]
   mutation_settings:
      mutation rate: 0.0-1.0
      affected_parameters: [parameter_list]
         schema_constraints: [validation_rules]

### Example 13

At step 406, the mutation generator 104 may validate the mutation to ensure that the mutation meets the genetic schema and would result in an operational network. If the mutation is not valid (step 406: NO), the mutation may be discarded (e.g., the neuron or connection is cloned without a mutation) and the mutation process 400 may return to step 402 to select the next neuron or connection. If the mutation is valid (step 406: YES), the mutation generator 104 may compile together the valid neurons and connections (step 408). The mutation generator 104 may then check if there are any additional neurons or connections left in the network (step 410). In some examples, the mutation generator 104 may determine if there are any additional neurons or connection if a neuron or connection limit in the genetic schema has not been met. If the mutation generator 104 determines that there are additional neurons or connections left in the network (step 410: YES), the mutation process 400 may return to step 402 to select the next neuron or connection. If the mutation generator 104 determines that there are no additional neurons or connections left in the network (step 410: NO), the mutation generator 104 may output a new network with one or more nodes and/or connections mutated according to step 404 (step 412). Example 14 illustrates an example mutated network.
#Example mutations
mutations:
   type: modify_gene
      target: Conv2D_1
      parameters:
      filters: 96 #Mutated from 64
      kernel_size: [5,5] #New enum value selected from [3,3], [5,5], [7,7]
   type: add_gene
      location: after (MaxPool2D_1)
gene:
   type: Conv2D
      filters: 64
      kernel size: [3,3]
   type: adjust_gene
      target: Dense_1
      parameter: dropout_rate
      new value: 0.3

### Example 14

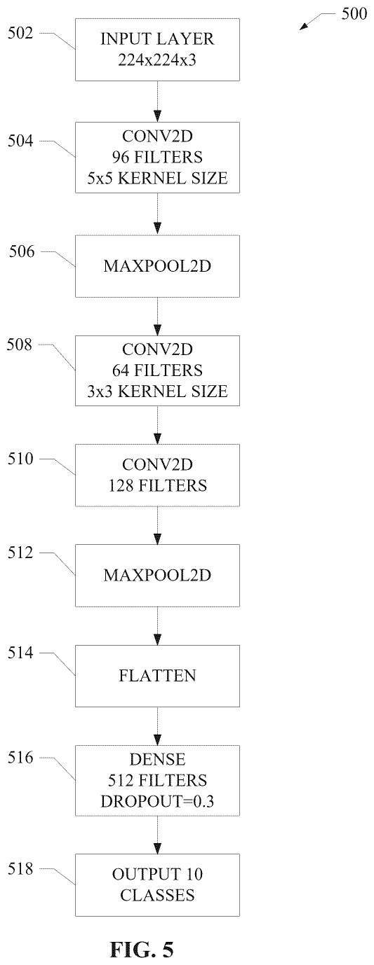

FIG. 5 illustrates an example mutated network variant 500. In some examples, the mutated network variant 500 is a mutated variant of base network 300 described with reference to FIG. 3 after the mutation process 400 described with reference to FIG. 4 is applied thereto. The example mutated network variant 500 may comprise an input layer 502 (224×224×3), a first convolutional layer 504 (96 filters, 5×5 kernel size), a first max pooling layer 506, a second convolutional layer 508 (64 filters, 3×3 kernel size), a third convolutional layer 510 (128 filters), a second max pooling layer 512, a flattening layer 514, a dense layer 516 (512 units, dropout 0.3), and an output layer 518 (10 classes). Comparing mutated network variant 500 to base network 300, the mutations may include: the first convolutional layer 504 mutated from 64 filters to 96 filters with an added 5×5 kernel size specification; an additional convolutional layer 508 inserted with 64 filters and 3×3 kernel size; and a dropout of 0.3 added to the dense layer 516. The mutated network variant may have various mutations and configurations, with the mutated network variant 500 of FIG. 5 being provided as an illustrated example.

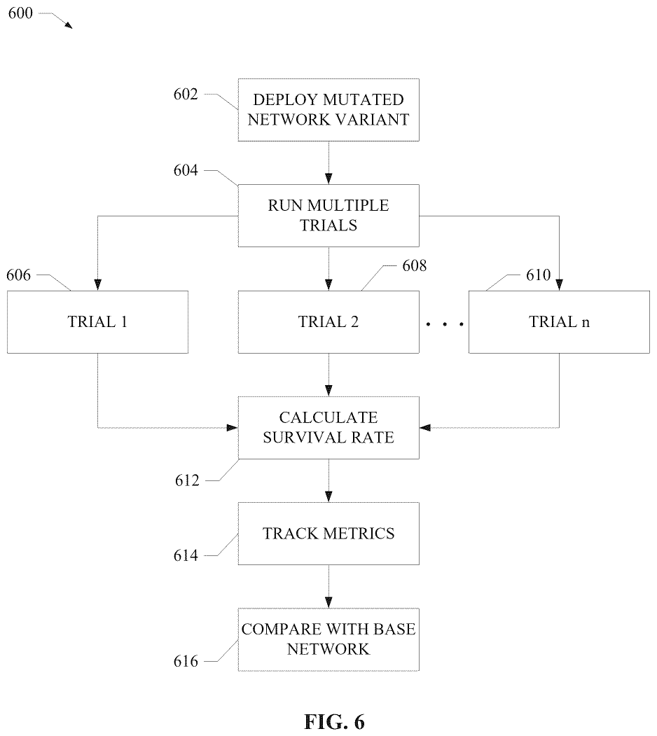

FIG. 6 illustrates an example mutation variant trial process 600. In some examples, the mutation variant trial process 600 may implement steps 208-210 described above with reference to FIG. 2. The mutation variant trial process 600 may begin at step 602 with the arena deployment system 106 deploying one or more mutated network variants within one or more evolutionary arena instances. At step 604, the arena deployment system 106 may configure multiple trials for which the mutations network variants may be subjected during a single round duration. In some examples, the arena deployment system 106 may run any number of trials including a first trial 606, a second trial 608, and up to an n trial 610. In some examples, these trials may be run in parallel. In some such examples, the network monitor 108 and/or the arena deployment system 106 may calculate the survival rate of the mutated network variant across all trials (step 612). In some examples, these trials may run in series. In some such examples, the network monitor 108 and/or the arena deployment system 106 may calculate the survival rate after each trial. In some example, the network monitor 108 may track metrics associated with the trials (step 614). At step 616, the network monitor 108 and/or the arena deployment system 106 may compare surviving mutated network variants (and their metrics) with the base network (and its metrics). Example 15 illustrates exemplary metrics tracked at step 614, which may be used in the comparison at step 616.
deployment_metrics:
   variant_id: mutation_284
   trials_completed: 100
   trial results:
      successes: 20
      failures: 80
      survival rate: 0.20 #Target rate for optimal evolution pressure
fitness trend:
   current rate: 0.20
   previous_rates:
      generation: 1
         rate: 0.12
      generation: 2
         rate: 0.15
      generation: 3
         rate: 0.20
   delta: +0.05 #Rate of improvement
   trend: increasing #Key indicator of evolution success
status: evolution progressing

### Example 15

In some examples, complex networks may be decomposed into specialized subnetworks with fixed interfaces that may evolve independently. In some examples, communication protocols between subnetworks may remain stable based on fixed interfaces. In some examples, the specialized subnetworks may evolve in accordance with the descriptions above simultaneously/in parallel. In some examples, multiple viable variants of each subnetwork (with different characteristics) may co-exist. In some examples, such independent and simultaneous evolution may address conflicting fitness objectives, exponential gene space growth, resource allocation inefficiencies, and difficulty in maintaining specialized traits.

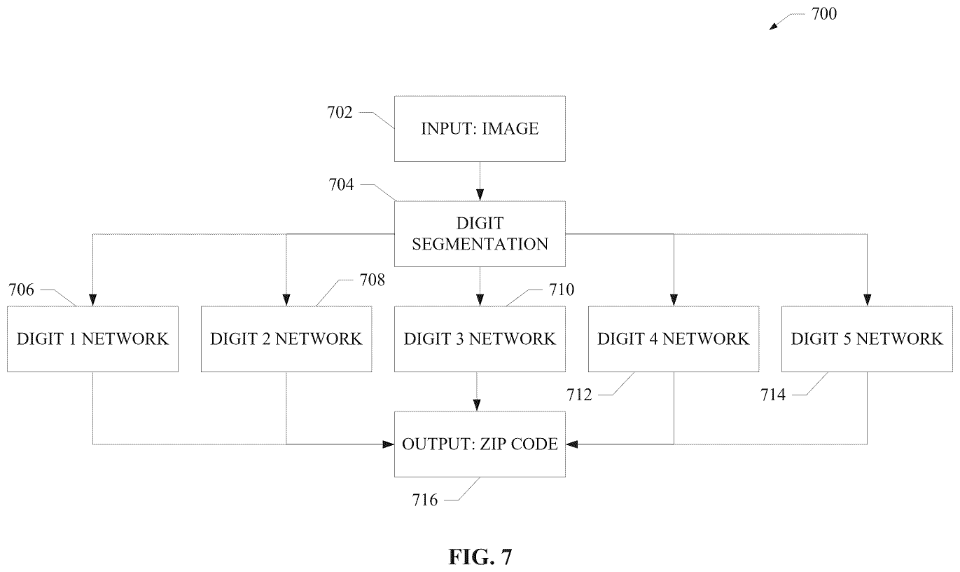

As an example of the foregoing decomposition principles, FIG. 7 illustrates an example process 700 for recognizing zip codes that may be decomposed into digit recognition subnetworks, each of which may evolve in its own evolutionary arena in parallel with the other digit recognition subnetworks. This decomposition may address conflicting fitness objectives (e.g., one digit position may require optimization for speed while another may require optimization for accuracy on difficult handwriting), exponential gene space growth (e.g., evolving five smaller networks rather than one large network), and resource allocation inefficiencies (e.g., allocating more computational resources to digit positions that historically show lower recognition accuracy).

At step 702 an input image (e.g., an image of a zip code) may be received by a zip code recognition network. The zip code recognition network may begin digit segmentation at step 704 to decompose recognition of the zip code into five subnetworks, each one to recognize a single digit of the zip code. At step 706, a first digit network may recognize a first digit of the zip code. At step 708, a second digit network may recognize a second digit of the zip code. At step 710, a third digit network may recognize a third digit of the zip code. At step 712, a fourth digit network may recognize a fourth digit of the zip code. At step 714, a fifth digit network may recognize a fifth digit of the zip code. Each of the first-fifth digit networks may evolve in accordance with the descriptions herein in order to improve its zip code digit recognition. Because each digit network may evolve in its own evolutionary arena in parallel and because each evolution may be based on random mutations and survival based adaptions, the first digit network may evolve differently than the second digit network, the third digit network, the fourth digit network, and the fifth digit network. Likewise, the second digit network may evolve differently than the first digit network, the third digit network, the fourth digit network, and the fifth digit network. Similarly, the third digit network may evolve differently than the first digit network, the second digit network, the fourth digit network, and the fifth digit network. Also, the fourth digit network may evolve differently than the first digit network, the second digit network, the third digit network, and the fifth digit network. And the fifth digit network may evolve differently than the first digit network, the second digit network, the third digit network, and the fourth digit network. At step 716, the zip code recognition network may compile the outputs of each digit network and output the recognized zip code. In this example, the fixed interface may be the standardized single-digit output (0-9) that each digit network provides to the compilation step 716, which remains stable regardless of how each digit network's internal architecture evolves.

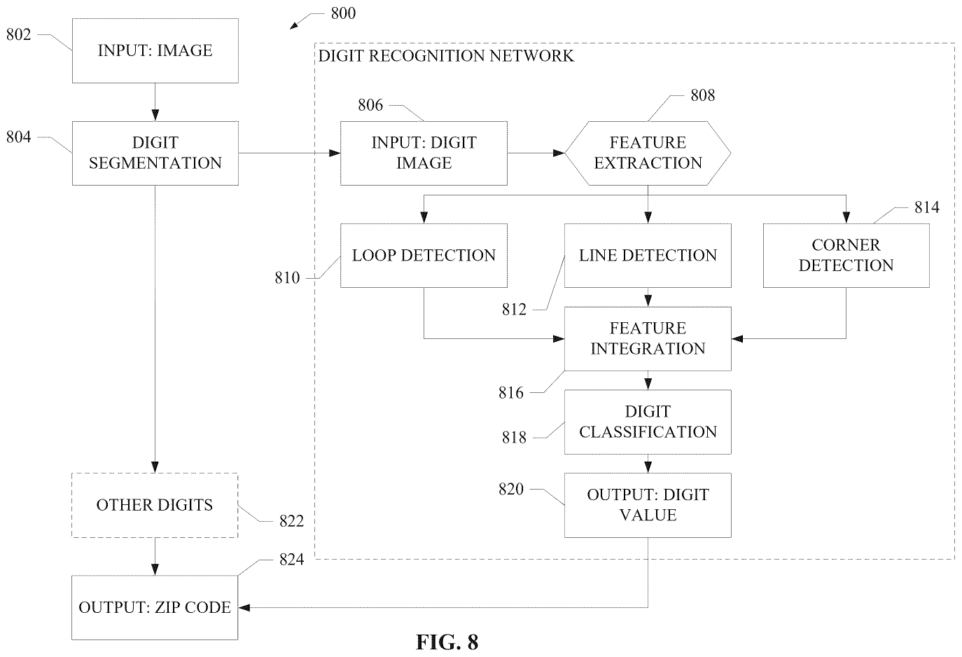

FIG. 8 illustrates an example process 800 similar to the example process 700, but with each digit recognition subnetwork decomposed into specialized feature detectors that themselves may evolve within independent evolutionary arenas. For example, network 800 may have an input step 802 similar to the input step 702 in FIG. 7 and a digit segmentation step 804 similar to the digit segmentation step 704 of FIG. 7. But digit recognition subnetworks 706-714 of FIG. 7 may be decomposed into an input step 806, a feature extraction step 808, a loop detection step 810, a line detection step 812, a corner detection step 814, a feature integration step 816, a digit classification step 818, and an output step 820. While one digit recognition network is shown in FIG. 8, the other digit recognition networks may function similarly, and may be processed in step 822. Like FIG. 7, the process 800 may also have an output step 824 in which the outputs of each digit recognition network may be compiled and output as a recognized zip code.

In some examples, the loop detection step 810 may be performed by a loop detection subnetwork that identifies closed circular or oval shapes within a digit image, which may be critical for distinguishing digits containing loops (e.g., 0, 6, 8, 9) from digits without loops (e.g., 1, 7). In some examples, the line detection step 812 may be performed by a line detection subnetwork that identifies straight line segments including vertical, horizontal, and diagonal strokes, which may be critical for recognizing digits characterized by linear features (e.g., 1, 4, 7). In some examples, the corner detection step 814 may be performed by a corner detection subnetwork that identifies angular intersections where line segments meet, which may be critical for distinguishing digits with sharp angular transitions (e.g., 4, 7) from digits with primarily curved features (e.g., 0, 3, 8).

In some examples, the loop detection subnetwork, the line detection subnetwork, and the corner detection subnetwork may be subject to the network evolution processes described herein, such that the loop detection subnetwork, the line detection subnetwork, and the corner detection subnetwork may evolve simultaneously. In some examples, the loop detection subnetwork, the line detection subnetwork, and the corner detection subnetwork may evolve independently, with one subnetwork emphasizing one feature, whereas another subnetwork may emphasize another feature (e.g., the loop detection subnetwork may evolve to optimize loop detection, the line detection subnetwork may evolve to optimize line detection, and the corner detection subnetwork may evolve to optimize corner detection). As an example, the loop detection subnetwork may evolve to better recognize variations in handwriting styles, the line detection subnetwork may evolve to better detect varying stroke thicknesses and angles, and the corner detection subnetwork may evolve to better distinguish sharp corners from rounded transitions.

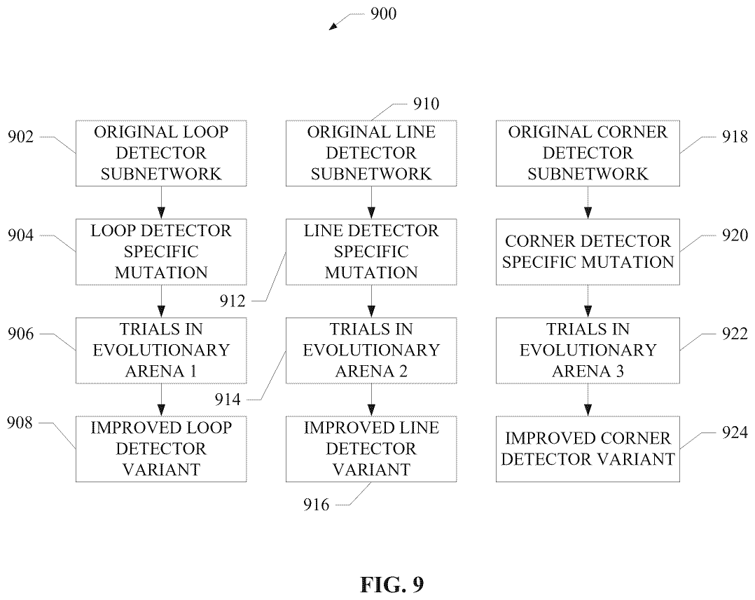

FIG. 9 illustrates a flow diagram of a process 900 illustrating simultaneous evolution of the loop detector subnetwork, the line detector subnetwork, and the corner detector subnetwork described above with reference to FIG. 8. As shown in FIG. 9, the network evolution process 200 may be applied to an original loop detector subnetwork at step 902. As described above, the mutation generator 104 may generate mutations based on the loop detector subnetwork (step 904). The arena deployment system 106 may subject the generated mutations of the loop detector subnetwork in one or more trials in one or more rounds of a first evolutionary arena (step 906). Based on surviving mutations, the network monitor 108 and/or the arena deployment system 106 may output an improved loop detector subnetwork variant (step 908). Step 902-908 may repeat.

Example 16 illustrates three evolved variants of the loop detector subnetwork.
cnn_based:
   fitness: 0.98
   latency: 5 ms
   resource_usage: high
   noise_tolerance: medium
transformer based:
   fitness: 0.97
   latency: 8 ms
   resource_usage: medium
   noise_tolerance: high
hybrid_approach:
   fitness: 0.97
   latency: 6 ms
   resource_usage: medium
   noise_tolerance: medium

### Example 16

Simultaneously with steps 902-908, the network evolution process 200 may be applied to an original line detector subnetwork at step 910. As described above, the mutation generator 104 may generate mutations based on the line detector subnetwork (step 912). The arena deployment system 106 may subject the generated mutations of the line detector subnetwork in one or more trials in one or more rounds of a second evolutionary arena (step 914). Based on surviving mutations, the network monitor 108 and/or the arena deployment system 106 may output an improved line detector subnetwork variant (step 916). Step 910-916 may repeat.

Simultaneously with steps 902-908 and 910-916, the network evolution process 200 may be applied to an original corner detector subnetwork at step 918. As described above, the mutation generator 104 may generate mutations based on the corner detector subnetwork (step 920). The arena deployment system 106 may subject the generated mutations of the corner detector subnetwork in one or more trials in one or more rounds of a third evolutionary arena (step 922). Based on surviving mutations, the network monitor 108 and/or the arena deployment system 106 may output an improved corner detector subnetwork variant (step 924). Step 918-924 may repeat.

In some examples, the mutation generator 104 may mutate a parent network (e.g., the network comprising the decomposed subnetworks) through the selection of different subnetwork variant combinations. In some examples, the mutation generator 104 may mutate a parent network by adjusting integration parameters between subnetworks. In some examples, the mutation generator 104 may mutate a parent network by optimizing resource allocation across components. In some examples, such parent mutation techniques may maintain interface and version compatibility throughout the various mutations. In some examples, such parent mutation techniques may not involve manual architectural decisions, may occur through random mutation and survival selection, may discover non-obvious synergistic combinations, may optimize system-level objectives naturally, and may maintain interface compatibility automatically. In some examples, these disclosed parent mutation techniques provide scalability by breaking complex problems (and networks) into manageable components, efficiency by enabling parallel evolution of components, reductions in computational costs, maintainability of isolated components that are easier to understand, reliability due to any failures being isolated to specific subnetworks, and optimized per-component resource allocation.

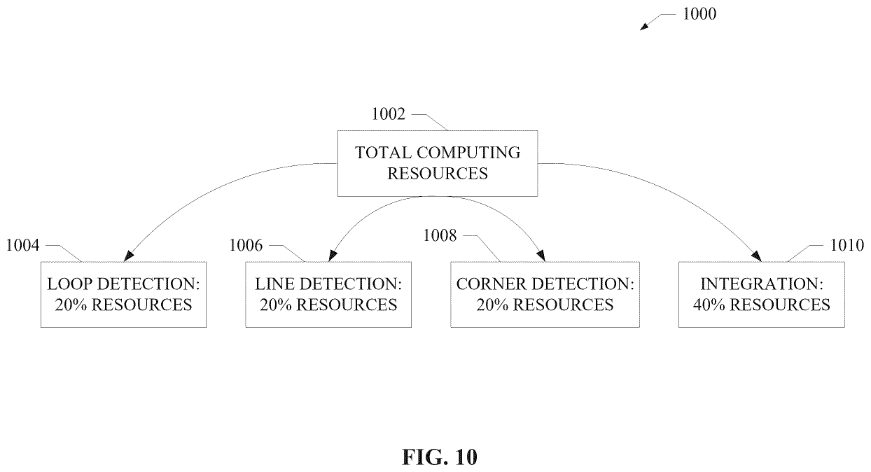

FIG. 10 is a block diagram 1000 illustrating optimized resource allocation across various components. As an example, the optimized pre-component resource allocation may allocate total computing resources 1002 among a loop detection subnetwork 1004, a line detection subnetwork 1006, and a corner detection subnetwork 1008. For example, 20% of computing resources may be allocated to the loop detection subnetwork 1004, 20% of computing resources may be allocated to the line detection subnetwork 1006, and 20% of computing resources may be allocated to the corner detection subnetwork 1008. In some examples, the remaining computing resources (e.g., 40%) may be allocated to integration 1010 of the outputs of the loop detection subnetwork 1004, the line detection subnetwork 1006, and the corner detection subnetwork 1008. Other example resource allocations may be determined and/or evolved based on the foregoing network evolution systems, methods, and apparatuses.

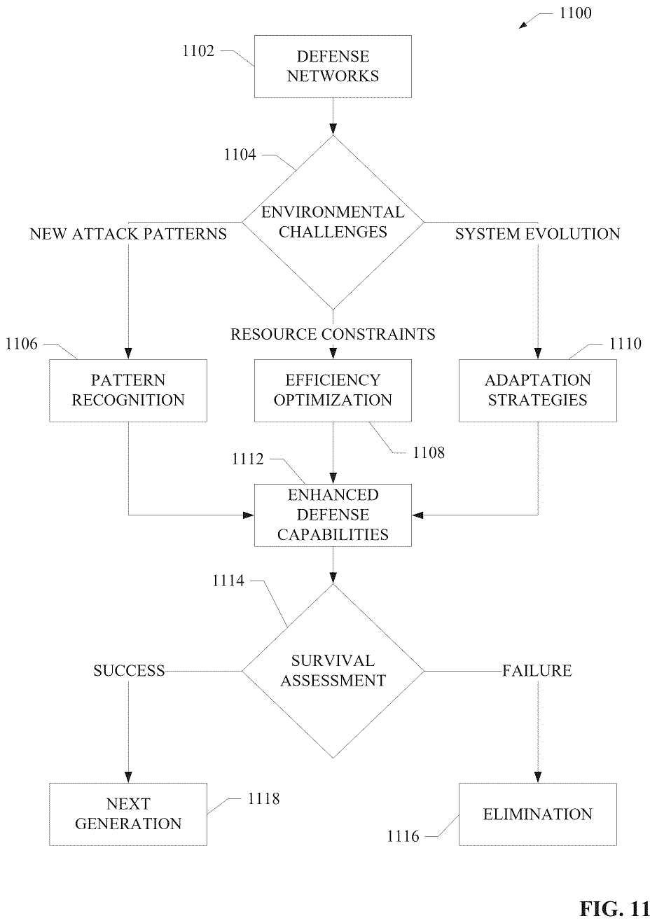

FIG. 11 illustrates a flow diagram of an exemplary process 1100 for implementing evolution of defense networks based on the network evolution systems, methods, and apparatuses described herein. In the context of cybersecurity, attack patterns constantly evolve, zero-day vulnerabilities are unpredictable, attacker actively adapt to defenses, system requirements may have to be maintained, and false positives may be extremely costly. At a minimum, the costs for the evolution arenas described herein scale linearly with arena complexity, rather than network complexity, thereby allowing for complex network analysis and evolution with minimal cost increases. Additionally, the network evolution systems, methods, and apparatuses disclosed herein may evolve with attack patterns and adaptions, thereby maintaining defenses and system requirements. And the network evolution systems, methods, and apparatuses disclosed herein, through the random mutations, may evolve to fix zero-day vulnerabilities.

In some examples, a key advantage of the evolutionary arena approach is that arena computational costs scale primarily with arena complexity rather than network complexity. In some examples, evolutionary arenas may test extremely simple networks or extremely complex networks with minimal difference in arena computational overhead. In some examples, this differs from traditional optimization approaches where computational costs for making architectural decisions may grow exponentially with network complexity. In some examples, evolution may not require understanding network complexity, such that complexity becomes a natural consequence of survival selection rather than a computational burden on the optimization process. In some examples, this enables exponential scaling of network sophistication beyond what human architects or traditional optimization systems could design or analyze.

The process 1100 may begin at step 1102 by applying the network evolution process 200 (FIG. 2) to one or more defense networks. The network evolution process 200 may subject the one or more defense networks to a number of environmental challenges at step 1104, including new attack patterns, resource constraints, and overall system evolution. At step 1106, the network evolution process 200 may introduce mutations to the one or more defense networks for better pattern recognition in identifying new attack patterns. For example, the one or more defense networks may mutate based on subtle attack signatures, behavioral anomalies, and event correlation across time. At step 1108, the network evolution process 200 may evolve the one or more defense networks to optimize efficiency to operate within resource constraints. For example, the one or more defense networks may mutate based on dynamic resource allocation, selective inspection depth, and automated containment strategies. At step 1110, the network evolution process 200 may evolve the one or more defense networks in adaptation strategies for general network evolution. For example, the one or more defense networks may mutate based on predictive threat assessment, attack surface adaptation, and resilience to novel attacks.

At step 1112, the one or more defense networks may be mutated based on one or more of the above evolutions to form one or more mutated defense networks with enhanced defense capability. Like in the network evolution process 200, the one or more mutated defense networks may be assessed for survival based on one or more criterion at step 1114. If the one or more mutated defense networks fail to satisfy any of the one or more criterion (step 1114: FAILURE), such mutated defense networks may be eliminated (step 1116). If the one or more mutated defense networks satisfy all of the one or more criterion (step 1114: SUCCESS), the one or more defense networks may be updated based on the mutated defense networks for the next generation (step 1118). Process 1100 may be repeated in a similar manner as described above with reference to the network evolution process 200 (FIG. 2). In the foregoing example, the one or more defense networks may evolve to handle new threats without explicit reprogramming. Continuous adaptation may occur through random mutation and survival selection, not manual rule updates. Example 17 illustrates exemplary evolutionary configurations for process 1100.
survival_thresholds:
   detection_rate: >=0.99
   false_positive_rate: <=0.001
   response_latency: <=10 ms
   resource_usage:
      cpu: <=2 cores
      memory: <=4 GB
environmental_complexities:
   attack_patterns:
      known_signatures: 1000
      polymorphic_variants: 10000
      zero_day_simulation: true
   traffic_conditions:
      normal_load: 100K req/s
      burst_peaks: 1M req/s
      protocol_mix: dynamic

### Example 17

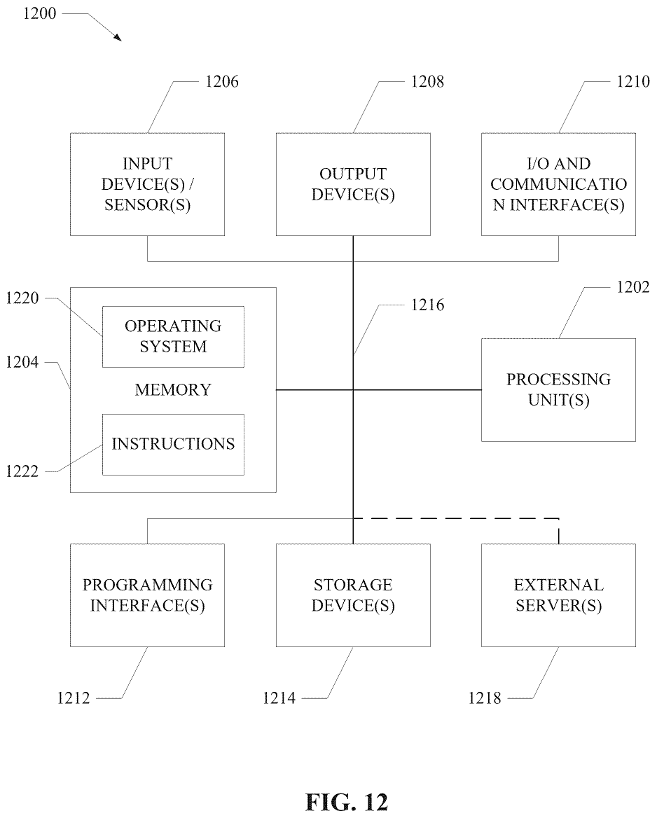

FIG. 12 illustrates an example computing device 1200 that may be used in accordance with the teachings described herein. The example computing device 1200 may be a computer, a tablet, a mobile device, a server, a workstation, an internet-of-things (IoT) device, a smart appliance, a network node, a hub, a router, a modem, or the like. The example computing device 1200 may comprise one or more processing units 1202, one or more memory 1204, one or more input devices or sensors 1206, one or more output devices 1208, one or more input/output (I/O) and communication interfaces 1210, one or more programming interfaces 1212, and one or more storage devices 1214. Each of the one or more processing units 1202, one or more memory 1204, one or more input devices or sensors 1206, one or more output devices 1208, one or more input/output (I/O) and communication interfaces 1210, one or more programming interfaces 1212, and one or more storage devices 1214 may be interconnected via wired connections such as, for example, a bus 1216. Alternatively, each of the one or more processing units 1202, one or more memory 1204, one or more input devices or sensors 1206, one or more output devices 1208, one or more input/output (I/O) and communication interfaces 1210, one or more programming interfaces 1212, and one or more storage devices 1214 may be interconnected wirelessly. In some examples, each of the one or more processing units 1202, one or more memory 1204, one or more input devices or sensors 1206, one or more output devices 1208, one or more input/output (I/O) and communication interfaces 1210, one or more programming interfaces 1212, and one or more storage devices 1214 may be interconnected via a combination of wired and wireless connections. In some examples, the example computing device 1200 may be connected to one or more external servers 1218.

In some examples, the processing unit 1202 may be a processor such as a central processing unit (CPU), a microprocessor, integrated circuit (IC), an application-specific integrated circuit (ASIC), a Field Programmable Gate Array (FPGA), a graphical processing unit (GPU), a quantum processor, a bioprocessor, a vector processor, a graph processor, or the like. In some examples, the computing device 1200 may have one or more processing units 1202 for parallel processing. In some such examples, the one or more processing units 1202 may be of the same type (e.g., multiple microprocessors). In some examples, the one or more processing units 1202 may be of different types (e.g., at least one CPU and at least one GPU). In some examples, the network evolution engine 100 may be implemented by the processing unit 1202.

In some examples, the memory 1204 may be a non-transitory computer readable storage medium. In some examples, the memory 1204 may include random-access memory, such as DRAM, SRAM, DDR RAM, or other random-access solid-state memory devices. In some examples, the memory 1204 may include an operating system 1220 and instructions 1222.

The operating system 1220 may be a traditional operating system that relies on pre-defined rules and structures such as, for example, Microsoft Windows®, Linux, macOS, etc. The operating system 1220 may be able to function effectively on a wide range of devices and platforms including smartphones, tablets, desktops, servers, etc. In some examples, the operating system 1220 may be decentralized, such that users may share resources and may collaborate without reliance on centralized servers. The instructions 1222 may comprise computer executable instruction sets for implementing the exemplary processes 200, 400, 600, 700, 800, 900, 1100 described above with reference to FIGS. 2, 4, 6, 7-9, and 11.

In some examples, the one or more input devices or sensors 1206 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 1208 may comprise one or more displays, one or more speakers, one or more lights (e.g., light emitting diodes), a signal generator, a haptics engine, a printer, or the like.

In some examples, the one or more I/O and communication interfaces 1210 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, I2C, or a similar type of interface.

In some examples, the one or more programming interfaces 1212 may comprise software for implementing one or more physical I/O and communication interfaces, application programming interfaces (APIs) configured for communication with and providing services to databases, software applications, the Internet, or the like.

In some examples, the one or more storage devices 1214 may comprise non-volatile memory, such as one or more magnetic disk storage devices, optical disk storage devices, flash memory devices, or other non-volatile solid-state storage devices. In some examples, the one or more storage devices 1214 may include one or more databases.

In some examples, the one or more external servers 1218 may comprise external processing and storage that may be utilized by the example computing device 1200. In some examples, the one or more external servers 1218 may be configured similarly to the example computing device 1200.

One or more example apparatus, systems, and computer-readable storage mediums are described below.

Example methods may comprise determining a universe of valid mutations of a network. Some methods may further involve configuring an environment to test network mutations against at least one criterion in at least one trial. Some methods may comprise generating, based on the network, based on randomized anomalies applied to at least one neuron or connection of the network, and based on the universe of valid mutations, a mutated network. In some methods, the mutated network may be deployed within the environment for a first round having a first criterion and a first time duration. Some methods may comprise discarding, based on the mutated network failing to satisfy the first criterion, the mutated network. Some methods may comprise creating, based on the mutated network satisfying the first criterion, an updated network.

Some methods may generate, based on the updated network, based on randomized anomalies applied to at least one neuron or connection of the updated network, and based on the universe of valid mutations, a second mutated network.

Some methods may deploy the second mutated network within the environment for a second round having a second criterion and a second time duration.

Some methods may discard, based on the second mutated network failing to satisfy the second criterion, the second mutated network.

Some methods may create, based on the second mutated network satisfying the second criterion, a second updated network.

Some methods may determine a configuration similarity by comparing a configuration of a network to a configuration of an updated network.

Some methods may compare the configuration similarity to a maximum threshold and based on the configuration similarity exceeding the maximum threshold, increase a mutation rate.

Some methods may select a first neuron or connection of the network, clone the selected first neuron or connection, apply a first randomized anomaly to the cloned selected first neuron or connection to create a first mutation, select a second neuron or connection, clone the selected second neuron or connection, apply a second randomized anomaly to the cloned selected second neuron or connection to create a second mutation, and compile the first mutation and the second mutation into the mutated network.

In some methods, the first mutation is subjected to a first trial and the first criterion, wherein the second mutation is subjected to a second trial and a second criterion, wherein the mutated network is discarded based on either the first mutation failing to satisfy the first criterion or the second mutation failing to satisfy the second criterion, and wherein the updated network is created based on the first mutation satisfying the first criterion and the second mutation satisfying the second criterion.

Some methods may determine a difference between a configuration of the network and a configuration of the updated network, compare the difference to a minimum threshold, and based on the difference failing to satisfy the minimum threshold, increase a mutation rate.

Some methods may determine a first survival rate based on a first number of mutated networks satisfying criteria during a first time period, determine a second survival rate based on a second number of mutated networks satisfying criteria during a second time period; and based on determining that the second survival rate is lower than the first survival rate by a threshold amount, decrease a rate of mutation.

Some methods may monitor a plurality of metrics associated with mutated networks.

Some methods may, based on the plurality of metrics, determine mutation parameter adjustments to apply in generating subsequent mutated networks.

Example apparatuses may comprise one or more processors and memory storing instructions that, when executed by the one or more processors, cause performance of any of the above methods.

Example non-transitory computer readable storage mediums may store instructions that, when executed, cause performance of any of the above methods.

Example systems may comprise a schema manager, a mutation generator, an arena deployment system, and a network monitor that are collectively configured to perform any of the above methods.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system comprising:
one or more processors; and
memory storing instructions that, when executed by the one or more processors, cause the system to:
determine a universe of valid mutations of a network;
configure an environment to test network mutations against at least one criterion in at least one trial;
generate, based on the network, based on randomized anomalies applied to at least one neuron or connection of the network, and based on the universe of valid mutations, a mutated network;
deploy the mutated network within the environment for a first round having a first criterion and a first time duration;
discard, based on the mutated network failing to satisfy the first criterion, the mutated network; and
create, based on the mutated network satisfying the first criterion, an updated network from the network and the mutated network.

2. The system of claim 1, wherein the instructions, when executed, further cause the system to:
generate, based on the updated network, based on randomized anomalies applied to at least one neuron or connection of the updated network, and based on the universe of valid mutations, a second mutated network;
deploy the second mutated network within the environment for a second round having a second criterion and a second time duration;
discard, based on the second mutated network failing to satisfy the second criterion, the second mutated network; and
create, based on the second mutated network satisfying the second criterion, a second updated network from the updated network and the second mutated network.

3. The system of claim 2, wherein the instructions further cause the system to:
determine a configuration similarity by comparing a configuration of the updated network to a configuration of the second updated network;
compare the configuration similarity to a maximum threshold; and
based on the configuration similarity exceeding the maximum threshold, increase a mutation rate.

4. The system of claim 1, wherein to generate the mutated network, the instructions further cause the system to:
select a first neuron or connection of the network;
clone the selected first neuron or connection;
apply a first randomized anomaly to the cloned selected first neuron or connection to create a first mutation;
select a second neuron or connection;
clone the selected second neuron or connection;
apply a second randomized anomaly to the cloned selected second neuron or connection to create a second mutation; and
compile the first mutation and the second mutation into the mutated network.

5. The system of claim 4, wherein the first mutation is subjected to a first trial and the first criterion, wherein the second mutation is subjected to a second trial and a second criterion, wherein the mutated network is discarded based on either the first mutation failing to satisfy the first criterion or the second mutation failing to satisfy the second criterion, and wherein the updated network is created based on the first mutation satisfying the first criterion and the second mutation satisfying the second criterion.

6. The system of claim 1, wherein the instructions further cause the system to:
determine a difference between a configuration of the network and a configuration of the updated network;
compare the difference to a minimum threshold; and
based on the difference failing to satisfy the minimum threshold, increase a mutation rate.

7. The system of claim 1, wherein the instructions further cause the system to:
determine a first survival rate based on a first number of mutated networks satisfying criteria during a first time period;
determine a second survival rate based on a second number of mutated networks satisfying criteria during a second time period; and
based on determining that the second survival rate is lower than the first survival rate by a threshold amount, decrease a rate of mutation.

8. The system of claim 1, wherein the instructions further cause the system to:
monitor a plurality of metrics associated with mutated networks; and
based on the plurality of metrics, determine mutation parameter adjustments to apply in generating subsequent mutated networks.

9. A computer readable storage medium storing instructions that, when executed, cause:
determining a universe of valid mutations of a network;
configuring an environment to test network mutations against at least one criterion in at least one trial;
generating, based on the network, based on randomized anomalies applied to at least one neuron or connection of the network, and based on the universe of valid mutations, a mutated network;
deploying the mutated network within the environment for a first round having a first criterion and a first time duration;
discarding, based on the mutated network failing to satisfy the first criterion, the mutated network; and
creating, based on the mutated network satisfying the first criterion, an updated network from the network and the mutated network.

10. The storage medium of claim 9, wherein the instructions, when executed, further cause:
generating, based on the updated network, based on randomized anomalies applied to at least one neuron or connection of the updated network, and based on the universe of valid mutations, a second mutated network;
deploying the second mutated network within the environment for a second round having a second criterion and a second time duration;
discarding, based on the second mutated network failing to satisfy the second criterion, the second mutated network; and
creating, based on the second mutated network satisfying the second criterion, a second updated network from the updated network and the second mutated network.

11. The storage medium of claim 10, wherein the instructions further cause:
determining a configuration similarity by comparing a configuration of the updated network to a configuration of the second updated network;
comparing the configuration similarity to a maximum threshold; and
based on the configuration similarity exceeding the maximum threshold, increasing a mutation rate.

12. The storage medium of claim 9, wherein the instructions further cause:
selecting a first neuron or connection of the network;
cloning the selected first neuron or connection;
applying a first randomized anomaly to the cloned selected first neuron or connection to create a first mutation;
selecting a second neuron or connection;
cloning the selected second neuron or connection;
applying a second randomized anomaly to the cloned selected second neuron or connection to create a second mutation; and
compiling the first mutation and the second mutation into the mutated network.

13. The storage medium of claim 12, wherein the first mutation is subjected to a first trial and the first criterion, wherein the second mutation is subjected to a second trial and a second criterion, wherein the mutated network is discarded based on either the first mutation failing to satisfy the first criterion or the second mutation failing to satisfy the second criterion, and wherein the updated network is created based on the first mutation satisfying the first criterion and the second mutation satisfying the second criterion.

14. The storage medium of claim 9, wherein the instructions further cause:
determining a difference between a configuration of the network and a configuration of the updated network;
comparing the difference to a minimum threshold; and
based on the difference failing to satisfy the minimum threshold, increasing a mutation rate.

15. The storage medium of claim 9, wherein the instructions further cause:
determining a first survival rate based on a first number of mutated networks satisfying criteria during a first time period;
determining a second survival rate based on a second number of mutated networks satisfying criteria during a second time period; and
based on determining that the second survival rate is lower than the first survival rate by a threshold amount, decreasing a rate of mutation.

16. The storage of claim 9, wherein the instructions further cause:
monitoring a plurality of metrics associated with mutated networks; and
based on the plurality of metrics, determining mutation parameter adjustments to apply in generating subsequent mutated networks.

17. A method comprising:
determining a universe of valid mutations of a network;
configuring an environment to test network mutations against at least one criterion in at least one trial;
generating, based on the network, based on randomized anomalies applied to at least one neuron or connection of the network, and based on the universe of valid mutations, a mutated network;
deploying the mutated network within the environment for a first round having a first criterion and a first time duration;
discarding, based on the mutated network failing to satisfy the first criterion, the mutated network; and
creating, based on the mutated network satisfying the first criterion, an updated network from the network and the mutated network.

18. The method of claim 17, further comprising:
determining a configuration similarity by comparing a configuration of the network to a configuration of the updated network;
comparing the configuration similarity to a maximum threshold; and
based on the configuration similarity exceeding the maximum threshold, increasing a mutation rate.

19. The method of claim 17, further comprising:
selecting a first neuron or connection of the network;
cloning the selected first neuron or connection;
applying a first randomized anomaly to the cloned selected first neuron or connection to create a first mutation;
selecting a second neuron or connection;
cloning the selected second neuron or connection;
applying a second randomized anomaly to the cloned selected second neuron or connection to create a second mutation; and
compiling the first mutation and the second mutation into the mutated network.

20. The method of claim 17, further comprising:
monitoring a plurality of metrics associated with mutated networks; and
based on the plurality of metrics, determining mutation parameter adjustments to apply in generating subsequent mutated networks.
